(19) United States
(12) Patent Application Publication
(10) Pub. No.: US 2009/0092939 A1
(43) Pub. Date: Apr. 9, 2009

(54) TORCH AND CANISTER

(75) Inventor: Michael R. Johnston, Troutman, NC (US)

Correspondence Address: MOORE & VAN ALLEN PLLC, P.O. BOX 13706, Research Triangle Park, NC, 27709, US

(73) Assignee: Irwin Industrial Tool Company, Huntersville, NC (US)

(21) Appl. No.: 11/866,732

(22) Filed: Oct. 3, 2007

(51) Int. Cl. F23D 14/28; F17C 1/00; F23D 14/38

(52) U.S. Cl. 431/344; 220/600; 29/428

(57) ABSTRACT

A fuel canister is provided comprising a vessel for containing a fuel. A fitment is located in a wall of the vessel and a gripping portion is located in another wall of the vessel. The gripping portion may include a rib formed by raised and recessed areas. The rib may also reinforce the wall of the canister. A torch is also provided comprising a torch body that is releasably connected to the fuel canister. A method of making a fuel canister is also provided comprising forming a vessel having a top wall and a side wall. The bottom wall is formed having at least one portion defining a flat or nearly flat surface. The bottom wall is welded or brazed to the side wall. External ribs may be formed in the bottom wall.

The invention relates generally to torches and, more particularly, to an improved fuel canister and torch.

### BACKGROUND

The invention relates to torches such as propane, butane, mixed gas or MAPP fueled torches that use a source of fuel that is ignited by a spark generated by, for example, a piezoelectric igniter (collectively “torches”). Such torches are used for heating, brazing, welding and the like.

Torches are known where a fuel canister is releasably connected to a torch head such as by a threaded connection. Typically the canister includes screw threads that threadably engage mating threads formed in the torch head. The torch head is threaded onto the canister by rotating the torch head relative to the canister multiple turns until the torch head is tightly secured to the canister.

### SUMMARY OF THE INVENTION

A fuel canister is provided comprising a vessel for containing a fuel. A fitment is located in a wall of the vessel and a gripping portion is located in another wall of the vessel. The gripping portion may include at least one external rib formed by raised and recessed areas. The rib may also reinforce the wall of the canister. A torch is also provided comprising a torch body that is releasably connected to the fuel canister. A method of making a fuel canister is also provided comprising forming a vessel having a top wall and a side wall. A bottom wall is formed having at least one portion defining a flat or nearly flat surface. The bottom wall is welded or brazed to the side wall. At least one external rib may be formed in the bottom wall.

### BRIEF DESCRIPTION OF THE DRAWINGS

FIG. 1 is a side view of an embodiment of a torch connected to a canister.

FIG. 2 is a side view of an embodiment of a canister.

FIG. 3 is a partially cut-away front view of the canister of FIG. 2.

FIG. 4 is a top view of the canister of FIG. 2.

FIG. 5 is a bottom view of the canister of FIG. 2.

FIG. 6 is a section view showing the fitment of the canister of FIG. 2.

FIG. 7 is a partially cut-away front view showing the assembly method of the canister of FIG. 2.

### DETAILED DESCRIPTION OF EMBODIMENTS OF THE INVENTION

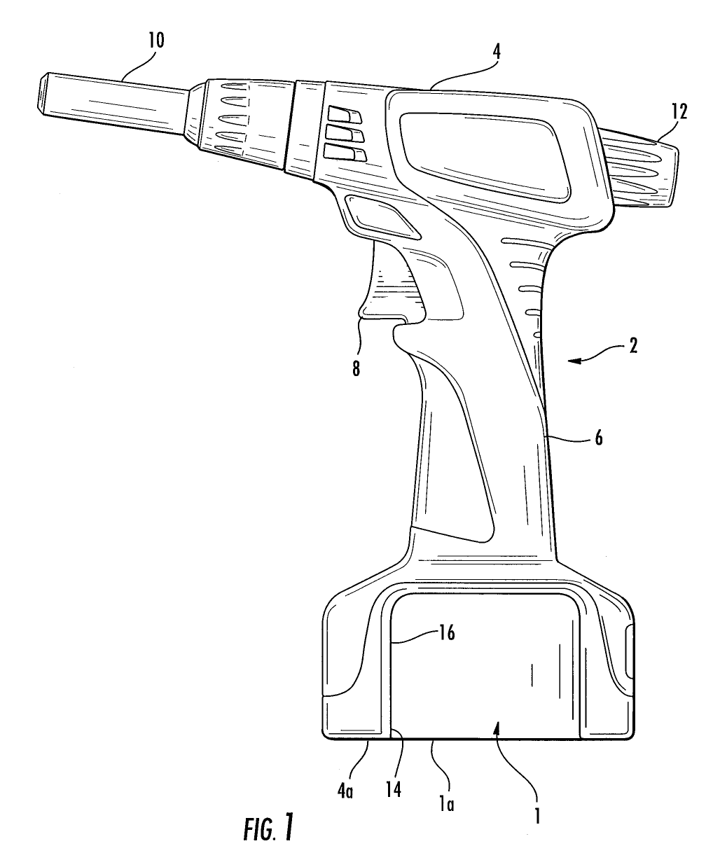

One embodiment of a torch 2 is shown in FIG. 1 and comprises a torch body 4 formed to have a trigger-type grip with a handle 6 that may be gripped by a user's hand such that a trigger 8 may be depressed by the fingers of the same hand to ignite the torch. The body 4 encloses a valve assembly and fuel line for controlling the flow of fuel from the canister 1 to the burn tube 10. The fuel is ignited in the burn tube 10 by, for example, a piezoelectric igniter. A control 12 may be provided for adjusting the flame size. In the illustrated embodiment the canister 1 is inserted into a receptacle 14 formed in the torch body 4 such that the end 1a of the canister 1 is substantially flush with the end 4a of the torch body 4. The receptacle 14 is dimensioned to receive the canister such that the torch body 4 extends over and in close proximity to at least a portion of the side wall of the canister 1. The torch body may have open portions 16 formed in the area of receptacle 14 to allow access to the canister when it is inserted in the torch body or the canister may be completely enclosed by the torch body. While an embodiment of a torch is shown and described herein, it is to be understood that the canister 1 may be used with other torches and with torch heads such as described in U.S. Pat No. 4,881,894 issued Nov. 21, 1989. Torches and torch heads are referred to collectively herein as torches.

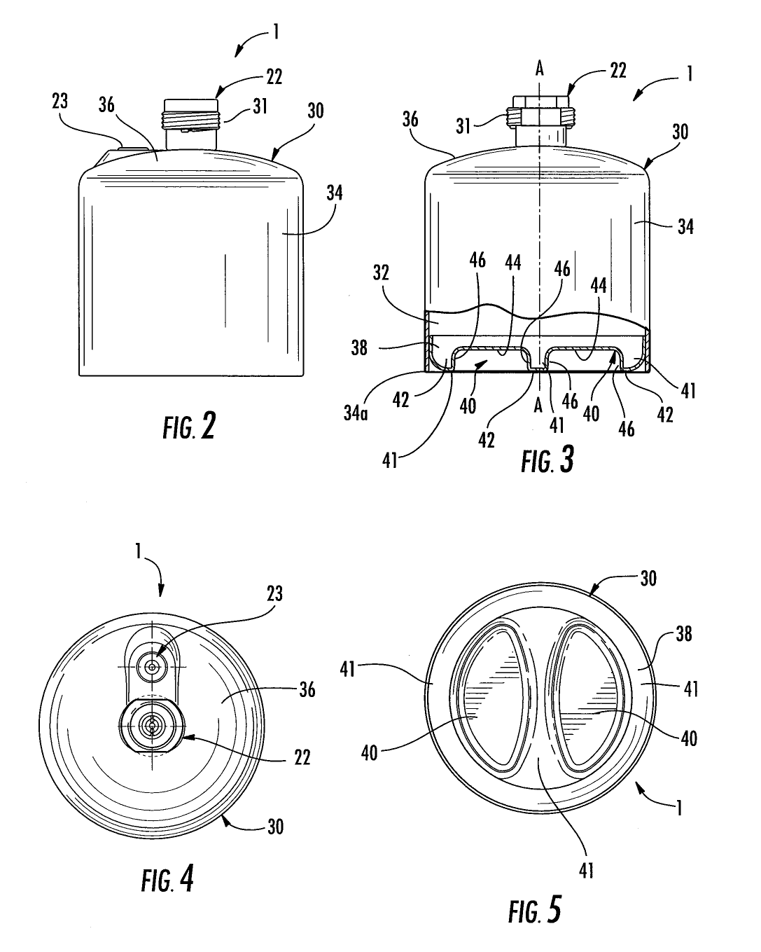

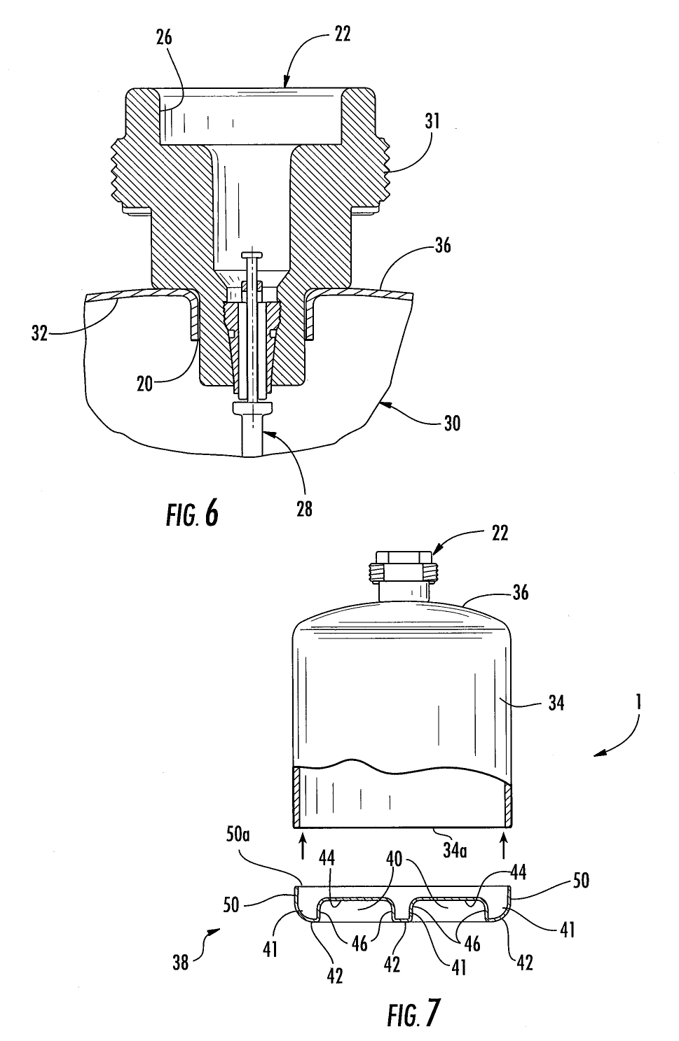

The canister 1 may contain a fuel such as propane, butane, MAPP gas, or the like. Referring to FIGS. 2 through 6, canister 1 comprises a vessel 30 for retaining a supply of fuel. The vessel 30 includes an interior chamber 32 defined by a side wall 34, a top wall 36 and a bottom wall 38. Top wall 36 receives a fitment 22 and a pressure relief valve 23.

Referring to FIG. 6, top wall 36 includes a port 20 for communicating the interior of the vessel 30 with the exterior. Fitment 22 is located in the port 20 for connecting the canister 1 to the torch body 4. The fitment 22 is secured in port 20 by any suitable mechanism such as welding or brazing to create a seal between the fitment 22 and the vessel 30. The fitment 22 includes a bore 26 that extends to the interior of the vessel 30 and through which fuel flows during the use of the torch. A valve 28 may be located in bore 26 to prevent the flow of fuel unless the torch head 2 is secured to the fitment 22. The fitment 22 includes a connector 31 for securely attaching the canister to the torch body. The connector 31 may include internal or external screw threads that releasably connect with mating screw threads formed on the torch 2. Further, the connector 31 and torch may include a quick connect coupling such that the canister 1 can be connected to the torch body 4 using a snap fit, push fit, partial turn fit or the like.

In the illustrated embodiment the side wall 34 has a generally cylindrical shape and terminates in a dome shaped top wall 36. The bottom wall 38 is formed with integral, external gripping portions 40 such that the gripping portions can be gripped by the fingers of a user's hand. The gripping portions 40 facilitate the attachment of the canister 1 to the torch by making it easier for a user to rotate the canister 1 relative to the torch. In one embodiment the gripping portions 40 include ribs 41 formed by raised areas 42 and recessed areas 44 connected by surfaces 46 that extend parallel to the axis A-A of the canister 1 such that a force can be applied to surfaces 46 to rotate the canister 1 about axis A-A. While a specific arrangement and shape of ribs 41 are shown it is to be understood that the ribs can be formed in a wide variety of shapes provided a user can gain purchase for manipulating the canister.

Use of the gripping portions 40 on the bottom wall 38 of canister 1 provides an area for a user to grip in order to position and/or rotate the canister relative to the torch during attachment to and detachment from the torch. It will be appreciated that in some applications and for some individuals grasping the side wall of the canister may be difficult. For example, in the torch illustrated in FIG. 1 the canister 1 is inserted into the torch body 4 such that the side wall 34 of the canister may be partially or totally obstructed by the torch body such that gripping the side wall of the canister after it is inserted into the torch body may be difficult. Further, even where the canister is accessible, gripping the exterior surface of the canister may be difficult because of the size of the canister, the slipperiness of its surface or the like. It will be understood that the bottom of the canister is readily accessible in torches such as the one shown in FIG. 1 such that gripping portions 40 may be easily gripped.

Referring to FIG. 7, the canister 1 may be made by first forming the side wall 34 and top wall 36 as an integral one-piece, unitary structure. The top wall 36 and side wall 34 may be formed of steel or other rigid material such as by stamping or other process. Fitment 22 may be welded into the port 20 formed in the top wall 36 to create a fluid tight seal therebetween.

The bottom wall 38 may then be formed in a separate process where the bottom wall is stamped or otherwise formed from a rigid material such as steel. The ribs 41 are formed during this process as is a peripheral wall portion 50. Peripheral wall portion 50 is configured and dimensioned so as to be closely received within the side wall 34. The area of contact between the interior of side wall 34 and the wall portion 50 provides sufficient surface area between the two components to allow a permanent connection therebetween. In one embodiment the bottom wall 38 is attached to the side wall 34 by welding or brazing. The height of wall portion 50 can vary provided a strong permanent connection is provided between the bottom wall 38 and side wall 34. Further, the bottom wall 38 may be dimensioned such that the wall portion 50 is located outside of the side wall 34 where the side wall 34 is closely received within the wall portion 50. A butt joint may also be used where the side wall 34 and bottom wall 38 have substantially the same size and shape such that the distal end 34a of side wall 34 abuts the distal end 50a of wall portion 50. In these arrangements a portion of the bottom wall 38 abuts or is closely adjacent to a portion of the side wall 34 such that a permanent fluid tight connection is created between the walls. The ribs 41, in addition to providing gripping portions 40, also reinforce the bottom wall 38 such that the bottom wall is capable of resisting the internal pressure exerted by the fuel.

The external surface of ribs 41 and the distal edge 34a of side wall 34 are shown in FIG. 3 positioned in the same plane such that the canister may be supported in an upright orientation on a substantially horizontal surface. The bottom wall 38 also may be recessed in the side wall 34 such that the plane on which the canister 1 is supported on a surface is defined by edge 34a. Further, the bottom wall 38 may be extended beyond the distal edge 34a of side wall 34 such that the plane on which the canister is supported on a surface is define by the external surfaces of ribs 41.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A fuel canister comprising:
a vessel having a side wall, a bottom wall and a top wall opposite to said bottom wall;
a fitment located in the top wall; and
a gripping portion located on said bottom wall.

2. The canister of claim 1 wherein said gripping portion includes at least one rib.

3. The canister of claim 1 wherein the gripping portion is formed by raised and recessed areas.

4. The canister of claim 1 wherein the gripping portion includes faces disposed parallel to an axis of rotation of the vessel.

5. The canister of claim 2 wherein said at least one rib reinforces said bottom wall.

6. The canister of claim 1 wherein said bottom wall is permanently connected to said sidewall.

7. The canister of claim 1 wherein said sidewall is a cylinder.

8. The canister of claim 1 wherein said top wall is domed.

9. The canister of claim 1 wherein said fitment includes a connector for connecting the canister to a torch.

10. The canister of claim 1 wherein the bottom wall defines a plane for supporting the canister.

11. The canister of claim 10 wherein a portion of said side wall defines a plane for supporting the canister.

12. The canister of claim 10 wherein a portion of said side wall further defines said plane.

13. The canister of claim 1 wherein said bottom wall includes a wall portion that is closely received in said side wall.

14. The canister of claim 1 wherein said bottom wall includes a wall portion that is closely adjacent said side wall.

15. A torch comprising:
a torch body;
a fuel canister connected to said torch body, said fuel canister comprising a
vessel having a side wall, a bottom wall and a top wall opposite to said bottom wall; a fitment located in the top wall releasably connected to said torch body;
and a gripping portion located in said bottom wall.

16. The torch of claim 15 wherein said torch body defines a receptacle into which said canister is inserted.

17. The torch of claim 16 wherein said canister is substantially entirely inserted into said receptacle.

18. The torch of claim 15 wherein said canister is rotated to connect said fitment to said torch body.

19. A method of making a fuel canister comprising:
forming a vessel having a top wall and a side wall;
forming a bottom wall having at least one portion defining a flat surface;
permanently connecting said bottom wall to said side wall.

20. The method of claim 19 further including locating a fitment in said top wall.

21. The method of claim 19 further including forming external ribs in said bottom wall.

22. The method of claim 19 wherein said bottom wall is welded to said side wall.

23. The method of claim 19 wherein said bottom wall is brazed to said side wall.

24. A fuel canister comprising:
a vessel having a side wall, a bottom wall and a top wall opposite to said bottom wall;
a fitment located in the top wall; and
a gripping portion located on said bottom wall, said gripping portion includes at least one rib formed by raised and recessed areas, said at least one rib reinforcing said bottom wall.

25. A fuel canister comprising:
a vessel having a side wall formed as a cylinder, a top wall formed as a dome and being integral with said side wall and a bottom wall, said bottom wall includes a wall portion that is closely received in said side wall and said bottom wall being welded or brazed to said side wall;
a fitment located in the top wall; and
a gripping portion located on said bottom wall.
